(19) United States
(12) Patent Application Publication
(10) Pub. No.: US 2007/0003702 A1
(43) Pub. Date: Jan. 4, 2007

(54) Method of preparing a metal-silicone rubber composite

(76) Inventors: Fumito Nishida, Midland, MI (US); Timothy Lauer, Freeland, MI (US); Udo Pernisz, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/573,622

(22) PCT Filed: Aug. 26, 2004
(86) PCT No.: PCT/US04/27743

§ 371 Date: Mar. 28, 2006

Related U.S. Application Data
(60) Provisional application No. 60/520,598, filed on Nov. 17, 2003.

(51) Int. Cl. B05D 1/36

(52) U.S. Cl. 427/402; 427/487; 264/259

(57) ABSTRACT

A method of preparing a metal-silicone rubber composite, the method comprising the steps of (i) depositing a layer of gold on a surface of a mold; (ii) depositing a primer layer of a metal on the layer of gold, wherein the metal is selected from aluminum, chromium, titanium, and copper, (iii) applying a radiation-curable silicone composition on the primer layer, (iv) curing the silicone composition with radiation to form a silicone rubber, and (v) removing the silicone rubber from the mold, whereby the layer of gold and the primer layer are transferred to the silicone rubber.

### FIELD OF THE INVENTION

The present invention relates to a method of preparing a metal-silicone rubber composite and more particularly to a method of preparing a metal-silicone rubber composite employing the transfer of metal layers to a silicone rubber.

### BACKGROUND OF THE INVENTION

Methods of metallizing elastomers are well known in the art. For example, metals can be directly deposited on elastomers using physical vapor deposition methods, such as thermal evaporation and sputtering. However, such methods are unsuitable for silicone elastomers, such as silicone gels and polymer-dispersed liquid crystals that are adversely affected by vacuum or elevated temperature.

Alternatively, methods of transferring metal films from a substrate to an elastomer are known. For example, Japanese Patent Application No. 03-267240 discloses a method of manufacturing a silicone rubber conductive sheet comprising forming a metallic thin film layer such as an aluminum metallized layer on a base sheet such as a polyester film, applying a liquid or solution-like silicone rubber onto the metallic thin film layer, forming a silicone rubber layer, and peeling off the resulting laminated sheet at an interface between the metallic thin film layer and base sheet. The metallic thin film layer is transferred to the silicone rubber layer to produce an electrically conductive silicone sheet. However, the silicone composition must be heated and/or exposed to low pressure to ensure complete removal of solvent. These conditions are unsuitable for heat or pressure sensitive silicone elastomers. Also, the application of heat often results in the formation of cracks and/or wrinkles in the transferred metal layer.

Consequently, there is a need for a method of preparing a metal-silicone rubber composite that avoids exposure of the silicone rubber to low pressure (i.e., vacuum) and/or elevated temperature.

### SUMMARY OF THE INVENTION

The present invention is directed to a method of preparing a metal-silicone rubber composite, the method comprising the steps of:
(i) depositing a layer of gold on a surface of a mold;
(ii) depositing a primer layer of a metal on the layer of gold, wherein the metal is selected from aluminum, chromium, titanium, and copper;
(iii) applying a radiation-curable silicone composition on the primer layer;
(iv) curing the silicone composition with radiation to form a silicone rubber; and
(v) removing the silicone rubber from the mold, whereby the layer of gold and the primer layer are transferred to the silicone rubber.

The method of the present invention, which avoids exposure of the silicone rubber to low pressure and elevated temperature, produces a metal-silicone rubber composite containing a layer of gold having reduced cracking and wrinkling compared to methods that subject the silicone rubber to heat and/or vacuum. Typically, the layer of gold is free of cracks and wrinkles, as determined by visual inspection with the unaided eye. Importantly, the method of the present invention permits the metallization of silicone rubber substrates, for example, silicone gels and polymer dispersed liquid crystals, which are sensitive to vacuum and/or elevated temperature. Also, the method employs conventional techniques and equipment and readily available silicone compositions. Further, the method is scaleable to a high throughput manufacturing process.

The method of the present invention can be used to fabricate numerous articles, including electrodes, printed circuits, electro-optic components having reflective surfaces or interfaces, and decorative ornamental articles.

These and other features, aspects, and advantages of the present invention will become better understood with reference to the following description and appended claims.

### DETAILED DESCRIPTION OF THE INVENTION

According to the present invention, a method of preparing a metal-silicone rubber composite, comprises the steps of:
(i) depositing a layer of gold on a surface of a mold;
(ii) depositing a primer layer of a metal on the layer of gold, wherein the metal is selected from aluminum, chromium, titanium, and copper;
(iii) applying a radiation-curable silicone composition on the primer layer;
(iv) curing the silicone composition with radiation to form a silicone rubber; and
(v) removing the silicone rubber from the mold, whereby the layer of gold and the primer layer are transferred to the silicone rubber.

In step (i) of the present method, a layer of gold is deposited on a surface of a mold. The mold can be constructed of any rigid material. Examples of suitable mold materials include, but are not limited to, polyolefins such as polyethylene and polypropylene; fluorocarbon polymers such as polytetrafluoroethylene and polyvinylfluoride; polystyrene; polyamides such as Nylon; polyimides; polyesters and acrylic polymers such as poly(methyl methacrylate); epoxy resins; polycarbonates; polysulfones; polyether sulfones; ceramics; and glass. Furthermore, the surface of the mold can have a coating of a release agent thereon.

The layer of gold typically has thickness of from 10 to 1000 nm, alternatively from 25 to 500 nm, alternatively form 50 to 200 nm. Methods of depositing gold are well known in the art For example, the layer of gold can be deposited on a surface of the mold by physical vapor deposition (PVD) methods, including thermal evaporation, DC magnetron sputtering, and RF sputtering.

In step (ii) of the method, a primer layer of a metal is deposited on the layer of gold, wherein the metal is selected from aluminum, chromium, titanium, and copper. The primer layer typically has thickness of from 1 to 200 nm, alternatively from 1 to 50 nm, alternatively form 1 to 10 nm. The primer layer can be deposited by conventional PVD methods, as described above for the layer of gold.

In step (iii) of the method, a radiation-curable silicone composition is applied on the primer layer. The radiation-curable silicone composition can be any silicone composition that cures upon exposure to radiation having a wavelength of from 250 to 400 nm. Radiation-curable silicone compositions are well known in the art. For example, the radiation-curable silicone composition can comprise (i) an organopolysiloxane containing radiation-sensitive functional groups and (ii) a photoinitiator. Examples of radiation-sensitive functional groups include acryloyl, methacryloyl, epoxy, and alkenyl ether groups. The type of photoinitiator depends on the nature of the radiation-sensitive groups in the organopolysiloxane. Examples of photoinitiators include diaryliodonium salts, sulfonium salts, acetophenone, benzophenone, and benzoin and its derivatives.

Alternatively, the radiation-curable silicone composition can comprise (i) an organopolysiloxane having an average of at least two alkenyl groups per molecule, (ii) a mercapto-functional compound in an amount sufficient to cure the composition, and (iii) a catalytic amount of a photoinitiator. For example, the radiation-curable silicone composition can comprise:
(A) an organopolysiloxane having an average of at least two alkenyl groups per molecule, a number-average molecular weight of from 1,000 to 50,000, and an average of from 10 to 90 mol % of silicon-bonded phenyl groups per molecule;
(B) a mercapto-functional compound in an amount sufficient to cure the composition, wherein the mercapto-functional compound is selected from (i) a mercapto-functional organosiloxane having an average of at least two mercaptoalkyl groups per molecule and (ii) a mercapto-functional organic compound having an average of at least two mercapto groups per molecule, and
(C) a catalytic amount of a photoinitiator.

Component (A) is at least one organopolysiloxane having an average of at least two alkenyl groups per molecule, a number-average molecular weight of from 1,000 to 50,000, and an average of from 10 to 90 mol % of silicon-bonded phenyl groups per molecule. The organopolysiloxane can have a linear or branched structure. The organopolysiloxane can be a homopolymer or a copolymer. The alkenyl groups typically have from 2 to 10 carbon atoms, alternatively from 2 to 6 carbon atoms. The alkenyl groups in the organopolysiloxane can be located at terminal, pendant, or both terminal and pendant positions. Examples of alkenyl groups include, but are not limited to, vinyl, allyl, butenyl, and hexenyl.

The remaining silicon-bonded organic groups (other than alkenyl) in the organopolysiloxane are independently selected from hydrocarbyl and halogen-substituted hydrocarbyl, both free of aliphatic unsaturation. These monovalent groups typically have from 1 to 20 carbon atoms, alternatively from 1 to 10 carbon atoms, alternatively from 1 to 6 carbon atoms. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, decyl, undecyl, dodecyl, tridecyl, tetradecyl, pentadecyl, hexadecyl, heptadecyl, and octadecyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl. Examples of halogen-substituted hydrocarbyl groups include, but are not limited to, 3,3,3-trifluoropropyl, 3-chloropropyl, chlorophenyl, and dichlorophenyl.

The organpolysiloxane typically has a number-average molecular weight of from 1,000 to 50,000, alternatively from 1,500 to 20,000, alternatively from 2,000 to 10,000, where the molecular weight is determined by gel permeation chromatography employing a low angle laser light scattering detector.

The organopolysiloxane typically has an average of from 10 to 90 mol %, alternatively from 20 to 60 mol %, alternatively from 30 to 55 mol %, of silicon-bonded phenyl groups per molecule. When the mol % of silicon-bonded phenyl groups is less than 10 mol %, the PDLC formed by curing the silicone composition has a transparency less than 80%.

Examples of organopolysiloxanes useful in the silicone composition include, but are not limited to, the following polysiloxanes:
(i) a dimethylvinylsiloxy-terminated poly(dimethylsiloxane-methylphenylsiloxane);
(ii) a dimethylvinylsiloxy-terminated poly(methylphenylsiloxane);
(iii) a diphenylvinylsiloxy-terminated poly(dimethylsiloxane-methylphenylsiloxane);
(iv) an organopolysiloxane resin comprising PhSiO_{3/2} units and Me₂ViSiO_{1/2} units;
(v) a dimethylvinylsiloxy-terminated poly(phenylvinylsiloxane); and
(vi) a diphenylvinylsiloxy-terminated poly(phenylvinylsiloxane); wherein Ph is phenyl and Me is methyl.

Component (A) can be a single organopolysiloxane or a mixture comprising two or more organopolysiloxanes that differ in at least one property, such as structure, viscosity, average molecular weight, siloxane units, and sequence.

Methods of preparing organopolysiloxanes suitable for use in the silicone composition, such as hydrolysis and condensation of organohalosilanes or equilibration of cyclic polydiorganosiloxanes, are well known in the art.

Component (B) is a mercapto-functional compound in an amount sufficient to cure the composition, wherein the mercapto-functional compound is selected from (i) a mercapto-functional organosiloxane having an average of at least two mercaptoalkyl groups per molecule and (ii) a mercapto-functional organic compound having an average of at least two mercapto groups per molecule. It is generally understood that crosslinking occurs when the sum of the average number of alkenyl groups per molecule in component (A) and the average number of mercapto groups per molecule in component (B) is greater than four.

Component (B)(i) is at least one mercapto-functional organosiloxane having an average of at least two mercaptoalkyl groups per molecule. The mercapto-functional organosiloxane typically has a number-average molecular weight less than 5,000, alternatively less than 2,000, alternatively less than 1,000. The mercapto-functional organosiloxane can be a disiloxane, trisiloxane, or polysiloxane. The structure of the mercapto-functional organosiloxane can be linear, branched, cyclic, or resinous. The mercaptoalkyl groups in the organosiloxane can be located at terminal, pendant, or both terminal and pendant positions. The mercaptoalkyl groups typically have from 1 to 10 carbon atoms, alternatively from 1 to 6 carbon atoms. Examples of mercaptoalkyl groups include, but are not limited to, mercaptomethyl, 2-mercaptoethyl, 4-mercaptobutyl, 3-mercapto-2-methylpropyl, and 6-mercaptohexyl.

The remaining silicon-bonded organic groups (other than mercaptoalkyl) in the mercapto-functional organosiloxane are independently selected from hydrocarbyl and halogen-substituted hydrocarbyl, both free of aliphatic unsaturation. These monovalent groups typically have from 1 to 20 carbon atoms, alternatively from 1 to 10 carbon atoms, alternatively from 1 to 6 carbon atoms. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, decyl, undecyl, dodecyl, tridecyl, tetradecyl, pentadecyl, hexadecyl, heptadecyl, and octadecyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl. Examples of halogen-substituted hydrocarbyl groups include, but are not limited to, 3,3,3-trifluoropropyl, 3-chloropropyl, chlorophenyl, and dichlorophenyl.

Examples mercapto-functional organosiloxanes include, but are not limited to, disiloxanes such as [HSCH₂CH₂CH₂(Me)₂Si]₂O; trisiloxanes such as [HSCH₂CH₂CH₂(Me)₂SiO]₃Si; and polysiloxanes such as a 3-mercaptopropyldimethylsiloxy-terminated poly(methylsiloxane) and a 3-mercaptopropyldimethylsiloxy-terminated poly(dimethylsiloxane-3-mercaptopropylmethylsiloxane); and an organosiloxane resin consisting essentially of HSCH₂CH₂CH₂SiO_{3/2} units and Me₃SiO_{1/2} units; wherein Me is methyl.

Component (B)(i) can be a single mercapto-functional organosiloxane or a mixture comprising two or more different mercapto-functional organosiloxanes. Methods of preparing mercapto-functional organosiloxanes are well known in the art.

Component (B)(ii) is at least one mercapto-functional organic compound having an average of at least two mercapto groups per molecule. The mercapto-functional organic compound typically has a molecular weight less than 5,000, alternatively less than 2,000, alternatively less than 1,000.

Examples of mercapto-functional organic compounds include, but are not limited to, CH₃CH₂C(CH₂CO₂CH₂CH₂SH)₃, 2,2′-dimercaptodiethyl ether, dipentaerythritolhaxa(3-mercaptopropionate), glycol dimercapto acetate, glycol dimercaptopropionate, pentaerythritol tetra(3-mercaptopropionate), pentaerythritol tetrathioglycolate, polyethylene glycol dimercaptoacetate having the formula HSCH₂COOCH₂(CH₂OCH₂)CH₂OOCCH₂SH, polyethylene glycol di(3-mercaptopropionate) having the formula HSCH₂CH₂COOCH₂(CH₂OCH₂)CH₂OOCCH₂CH₂SH, trimethylolethane tri(3-mercaptopropionate), trimethylolethane trithioglycolate, trimethyolpropoane tri(3-mercaptopropionate), and trimethylolpropane trithioglycolate.

Component (B)(ii) can be a single mercapto-functional compound or a mixture comprising two or more different mercapto-functional compounds. Methods of preparing mercapto-functional organic compounds are well known in the art; many of these compounds are commercially available.

The concentration of component (B) in the silicone composition of the present invention is sufficient to cure (crosslink) the composition. The exact amount of component (B) depends on the desired extent of cure, which generally increases as the ratio of the number of moles of mercapto groups in component (B) to the number of moles of alkenyl groups in component (A) increases. The concentration of component (B) is typically sufficient to provide from 0.5 to 2 mercapto groups, alternatively from 0.9 to 1.1 mercapto groups, per alkenyl group in component (A).

Component (C) is at least one photoinitiator. The photoinitiator can be any free radical initiator capable of catalyzing the addition reaction of component (A) with component (B) upon exposure to ultraviolet radiation having a wavelength of from 250 to 400 nm.

Examples of photoinitiators include, but are not limited to, benzophenone, acetonaphthone, acetophenone, benzoin methylether, benzoin isobutylether, 2,2-diethoxyacetophenone,

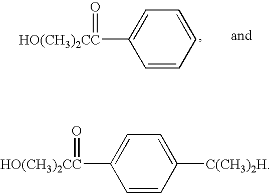

The photoinitiator can also be a polysilane, such as the phenylmethylpolysilanes defined by West in U.S. Pat. No. 4,260,780, which is hereby incorporated by reference; the aminated methylpolysilanes defined by Baney et al. in U.S. Pat. No. 4,314,956, which is hereby incorporated by reference; the methylpolysilanes of Peterson et al. in U.S. Pat. No. 4,276,424, which is hereby incorporated by reference; and the polysilastyrene defined by West et al. in U.S. Pat. No. 4,324,901, which is hereby incorporated by reference.

Component (C) can be a single photoinitiator or a mixture comprising two or more different photoinitiators.

The concentration of component (C) is sufficient to catalyze the addition reaction of component (A) with component (B). The concentration of component (C) is typically from 0.1 to 6% (w/w), alternatively from 1 to 3% (w/w), based on the combined weight of components (A) and (B).

The radiation-curable silicone composition can further comprise (D) a liquid crystal miscible in components (A) and (B) combined, wherein the liquid crystal is selected from (i) at least one compound having the formula: 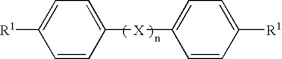
and (ii) a mixture comprising (i) and from 1 to 10% of at least one terphenyl compound having the formula: 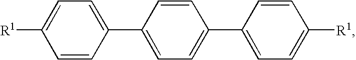
wherein each R¹ is independently selected from C₁ to C₂₀ alkyl, C₅ to C₈ cycloalkyl, —OR², —O(O═)CR², —C≡N, —NO₂, —CH═CHCOOR², —F, —Cl, —Br, and —I, wherein R² is C₁ to C₂₀ alkyl, X is a divalent organic group selected from —CH═N—, —N═N—, —N═N(O)—, —CH═CH—, —C≡C—, —C(═O)O—, and —CH═N—N═CH—, and n is 0 or 1. As used herein, the term “miscible” means component (D) is completely soluble in components (A) and (B) combined in the stated proportions.

The liquid crystal can be nematic, smetic, or cholesteric. Furthermore, the liquid crystal can have either positive or negative diamagnetic anisotropy.

Component (D)(i) is at least one compound having the formula: 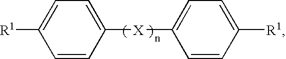
wherein R¹, X, and n are as defined above. When n is 0, component (D)(i) has the formula: 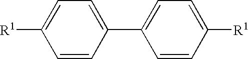
wherein R¹ is as defined above.

Alkyl groups represented by R¹ and R² typically have from 1 to 20 carbon atoms, alternatively from 1 to 10 carbon atoms, alternatively from 1 to 6 carbon atoms. Alkyl groups containing at least 3 carbon atoms can have a branched or unbranched structure. Examples of alkyl groups include, but are not limited to, methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, decyl, undecyl, dodecyl, tridecyl, tetradecyl, pentadecyl, hexadecyl, heptadecyl, and octadecyl.

Cycloalkyl groups represented by R¹ typically have from 5 to 8 carbon atoms. Examples of cycloalkyl groups include, but are not limited to, cyclopentyl, cyclohexyl, and methylcyclohexyl.

Examples of compounds suitable for use as component (D)(i) include, but are not limited to, 4-alkyl-4′cyanobiphenyl compounds, such as 4-n-pentyl4′-cyanobiphenyl, 4-n-hexyl4′-cyanobiphenyl, 4-n-octyl-4′-cyanobiphenyl; 4-alkyl-4′-alkoxybiphenyl, such as 4-n-pentyl-4′-ethoxybiphenyl; 4-alkyl-4′-halobiphenyl, such as 4-n-butyl-4′-fluorobiphenyl; and compounds having the formula: 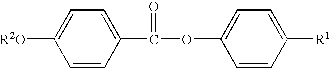
where R¹ and R² are C₁ to C₂₀ alkyl, as exemplified above.

Component (D)(i) can be a single compound or a mixture comprising two or more different compounds, each as described above.

Methods of preparing liquid crystals suitable for use as component (D)(i) are well known in the art; many of these compounds are commercially available.

Component (D)(ii) is a mixture comprising (D)(i) and from 1 to 10% of at least one terphenyl compound having the formula: 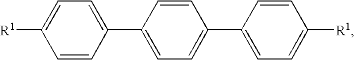
wherein R¹ is as defined and exemplified above.

Examples of terphenyl compounds include, but are not limited to, 4-alkyl-4″-cyanoterphenyl compounds, such as 4-n-pentyl-4″-cyanoterphenyl, 4-n-hexyl-4″-cyanoterphenyl, 4-n-octyl-4″-cyanoterphenyl; 4-alkyl-4″-alkoxyterphenyl, such as 4-n-pentyl-4″-ethoxyterphenyl; and 4-alkyl-4″-halolterphenyl, such as 4-n-butyl-4″-fluoroterphenyl.

The concentration of the terphenyl compound in component (D)(ii) is typically from 1 to 10% (w/w), alternatively from 1 to 8% (w/w), alternatively from 4 to 7% (w/w), based on the total weight of component (D)(ii).

Methods of preparing terphenyl compounds suitable for use in component (D)(ii) are well known in the art; many of these compounds are commercially available.

The concentration of component (D)) is typically from 1 to 200 parts by weight, alternatively from 1 to 110 parts by weight, alternatively from 10 to 100 parts by weight, alternatively from 30 to 90 parts by weight, per 100 parts by weight of component (A).

The radiation-curable silicone composition can be applied on the primer layer using any conventional method, such as filling, dipping, spraying, or brushing.

The radiation curable silicone composition of step (iii) can contain additional ingredients, provided the ingredient does not prevent the composition from curing to form a silicone rubber that can be removed from the mold with transfer of the metal layers from the mold to the silicone rubber. Examples of additional ingredients include, but are not limited to, inhibitors; sensitizers; fillers, such as reinforcing fillers, extending fillers, and conductive fillers; and fluorescent dyes.

In step (iv) of the method, the radiation-curable silicone composition is cured with radiation to form a silicone rubber. The radiation typically has a wavelength of from 250 to 400 nm. The dose of radiation is typically from 5 to 200 mJ/cm², alternatively from 20 to 100 mJ/cm². The cure temperature of the silicone composition depends on several factors, including the nature of the radiation-sensitive groups (e.g., mercapto, acryloyl, epoxy, alkenyl ether) in the silicone composition and the use temperature of the metal-silicone rubber composite. Typically, the silicone composition is cured at a temperature of from 10 to 30° C., alternatively from 15 to 25° C., below the use temperature of the metal-silicone rubber composite. Under these cure conditions, shrinkage of the silicone composition during curing offsets (±20%) expansion of the silicone rubber at the use temperature of the composite. As a result, the gold layer in the composite has reduced cracking and wrinkling. For example, the silicone compositions in Examples 1 and 2, below, are cured at a temperature of 4° C., about 20° C. below the intended use temperature of the metal-silicone rubber composite. The use temperature of the metal-silicone composite is typically from −20 to +60° C., alternatively from −10 to +40° C. Typically, the silicone composition is cured at a temperature of from −10 to +15° C., alternatively from −5 to +15° C., alternatively from 0 to 10 ° C.

In step (iv) of the method, the silicone rubber is removed from the mold, whereby the layer of gold and the primer layer are transferred to the silicone rubber. The metal-silicone composite comprises a silicone rubber substrate; a primer layer of a metal on the substrate, wherein the metal is selected from aluminum, chromium, titanium, and copper; and a layer of gold on the primer layer. The layer of gold in the metal-silicone rubber composite is typically free of cracks and wrinkles, as determined by visual inspection with the unaided eye.

The method of the present invention, which avoids exposure of the silicone rubber to low pressure and elevated temperature, produces a metal-silicone rubber composite containing a layer of gold having reduced cracking and wrinkling compared to methods that subject the silicone rubber to heat and/or vacuum. Typically, the layer of gold is free of cracks and wrinkles, as determined by visual inspection with the unaided eye. Importantly, the method of the present invention permits the metallization of silicone rubber substrates, for example, silicone gels and polymer dispersed liquid crystals, which are sensitive to vacuum and/or elevated temperature. Also, the method employs conventional techniques and equipment and readily available silicone compositions. Further, the method is scaleable to a high throughput manufacturing process.

The method of the present invention can be used to fabricate numerous articles, including electrodes, printed circuits, electro-optic components having reflective surfaces or interfaces, and decorative ornamental articles.

### EXAMPLES

The following examples are presented to better illustrate the metal-silicone composite of the present invention, but are not to be considered as limiting the invention, which is delineated in the appended claims. Unless otherwise noted, all parts and percentages reported in the examples are by weight. The following materials were employed in the examples:
Novec™ EGC-1700: an electronics coating, sold by 3M Corporation, consisting of a low viscosity solution of a fluorochemical acrylate polymer diluted in a hydrofluoroether solvent.
Darocur® 4265: a photoinitiator, sold by CIBA Specialty Chemicals, consisting of 50% of 2-hydroxy-2-methyl-1-phenyl-propan-1-one and 50% of 2,4,6-trimethylbenzoyldiphenylphosphine oxide.
Glass mold: a concave glass mold having a diameter of 50 mm and maximum depth of 7 mm.

### Example 1

A glass mold was treated with Novec™ EGC-1700 and air-dried. Gold (100 nm) was deposited on the glass mold and then 200 nm of aluminum was deposited on the gold, each metal deposited by thermal evaporation. The mold was filled with a curable silicone composition consisting of 95.2% of a dimethylvinylsiloxy-terminated organpolysiloxane consisting essentially of 70 mol % of PhMeSiO_{2/2} units, 27 mol % of Me₂SiO_{2/2} units, and 3 mol % of Me₂ViSiO_{1/2} units, wherein the organopolysiloxane has a number-average molecular weight of 6,161 and a weight-average molecular weight of 11,320; 3.9% of a mercapto-functional organic compound having the formula CH₃CH₂C(CH₂CO₂CH₂-CH₂SH)₃; and 0.9% of Darocur 4265. The silicone composition was cured under nitrogen at 4° C. for 10 min using a portable UV lamp (Spectroline® EN-160L) having a wavelength of 365 nm. The silicone rubber was removed from the mold with transfer of the metal layers from the glass mold to the rubber. The gold layer in the metal-silicone composite was highly reflective and free of cracks and wrinkles, as determined by visual inspection (unaided eye). The gold layer also exhibited high electrical conductivity.

### Example 2

A glass mold was treated with Novec™ EGC-1700 and air-dried. Gold (200 nm) was deposited on the glass mold and then 100 nm of aluminum was deposited on the gold, each metal deposited by thermal evaporation. The mold was filled with a curable silicone composition consisting of 75% of the silicone composition of Example 1 and 25% of 4-n-pentyl-4′-cyanobiphenyl (H.W. Sand Corporation). The silicone composition was cured under nitrogen at 4° C. for 10 min using a portable UV lamp (Spectroline® EN-160L) having a wavelength of 365 nm. The silicone rubber was removed from the mold with transfer of the metal layers from the glass mold to the rubber. The gold layer in the metal-silicone composite was highly reflective and free of cracks and wrinkles, as determined by visual inspection (unaided eye). The gold layer also exhibited high electrical conductivity.

### Comparative Example 1

A glass mold was treated with Novec™ EGC-1700 and air-dried. Gold (200 nm) was deposited on the glass mold and then 1.3 nm of aluminum was deposited on the gold, each metal deposited by thermal evaporation. The mold was filled with a curable silicone composition consisting of 94.2% of a dimethylvinylsiloxy-terminated organpolysiloxane consisting essentially of 70 mol % of PhMeSiO_{2/2} units, 27 mol % of Me₂SiO_{2/2} units, and 3 mol % of Me2ViSiO_{1/2} units, wherein the organopolysiloxane has a number-average molecular weight of 6,161 and a weight-average molecular weight of 11,320; 4.4% of an organohydrogensiloxane having the formula Si(OSiMe₂H)₄; 0.7% of a solution consisting of 38% of 1,3-divinyl-1,1,3,3-tetramethyldisiloxane and 62% of a platinum(IV) complex of 1,3-divinyl-1,1,3,3-tetramethyldisiloxane, and 0.7% of 1,3,5,7-tetramethyl-1,3-5,7-tetravinylcyclotetrasiloxane. The silicone composition was cured at 80° C. for 1 h. The silicone rubber was removed from the mold with transfer of the metal layers from the glass mold to the rubber. The gold layer in the metal-silicone composite was wrinkled, as determined by visual inspection (unaided eye).

### Comparative Example 2

A glass mold was treated with Novec™ EGC-1700 and air-dried. The mold was filled with a silicone composition consisting of 75% of the silicone composition of Comparative Example 1 and 25% of 4-n-pentyl4′-cyanobiphenyl (H.W. Sand Corporation). The composition was cured at 80° C. for 1 h. The silicone rubber was removed from the mold and placed in a vacuum chamber for metal deposition. Aluminum (100 nm) was deposited on the convex surface of the silicone rubber by thermal evaporation. After deposition, the surface of the silicone rubber was covered with transparent yellow oil, suggesting reaction of the aluminum with the liquid crystal.

### Comparative Example 3

A glass mold was treated with Novec™ EGC-1700 and air-dried. The mold was filled with the silicone composition of Comparative Example 2 and the composition was cured at 80° C. for 1 h. The cured silicone composition was removed from the mold and placed in a vacuum chamber for metal deposition. Gold (100 nm) was deposited on the convex surface of the silicone rubber by thermal evaporation. The gold layer had a tarnished appearance and poor electrical conductivity.

That which is claimed is:

1. A method of preparing a metal-silicone rubber composite, the method comprising the steps of:
(i) depositing a layer of gold on a surface of a mold;
(ii) depositing a primer layer of a metal on the layer of gold, wherein the metal is selected from aluminum, chromium, titanium, and copper;
(iii) applying a radiation-curable silicone composition on the primer layer;
(iv) curing the silicone composition with radiation to form a silicone rubber; and
(v) removing the silicone rubber from the mold, whereby the layer of gold and the primer layer are transferred to the silicone rubber.

2. The method according to claim 1, wherein the surface of the mold has a release coating thereon.

3. The method according to claims 1 or 2, wherein the layer of gold has a thickness of from 25 to 500 nm.

4. The method according to claims 1, 2, or 3, wherein the primer layer has a thickness of from 1 to 50 nm.

5. The method according to claims 1, 2, 3, or 4, wherein the primer layer is aluminum.

6. The method according to clams 1, 2, 3, 4, or 5, wherein the radiation-curable silicone composition comprises (i) an organopolysiloxane containing radiation-sensitive functional groups and (ii) a photoinitiator.

7. The method according to claims 1, 2, 3, 4, 5 or 6, wherein the radiation-curable silicone composition comprises (i) an organopolysiloxane having an average of at least two alkenyl groups per molecule, (ii) a mercapto-functional compound in an amount sufficient to cure the composition, and (iii) a catalytic amount of a photoinitiator.

8. The method according to claim 7, wherein the radiation-curable silicone composition comprises (A) an organopolysiloxane having an average of at least two alkenyl groups per molecule, a number-average molecular weight of from 1,000 to 50,000, and an average of from 10 to 90 mol % of silicon-bonded phenyl groups per molecule;
(B) a mercapto-functional compound in an amount sufficient to cure the composition, wherein the mercapto-functional compound is selected from (i) a mercapto-functional organosiloxane having an average of at least two mercaptoalkyl groups per molecule and (ii) a mercapto-functional organic compound having an average of at least two mercapto groups per molecule, and
(C) a catalytic amount of a photoinitiator.

9. The method according to claim 8, wherein the radiation-curable silicone composition further comprises (D) a liquid crystal miscible in components (A) and (B) combined, wherein the liquid crystal is selected from (i) at least one compound having the formula: 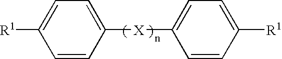
and (ii) a mixture comprising (i) and from 1 to 10% of at least one terphenyl compound having the formula: 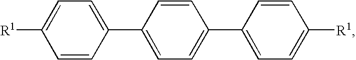
wherein each R¹ is independently selected from C₁ to C₂₀ alkyl, C₅ to C₈ cycloalkyl, —OR², —O(O═)CR², —C≡N, —NO₂, —CH═CHCOOR², —F, —Cl, —Br, and —I, wherein R² is C₁ to C₂₀ alkyl, X is a divalent organic group selected from —CH═N—, —N═N—, —N═N(O)—, —CH═CH—, —C≡C—, —C(═O)O—, and —CH═N—N═CH—, and n is 0 or 1.
